(19) United States
(12) Patent Application Publication
(10) Pub. No.: US 2014/0208127 A1
(43) Pub. Date: Jul. 24, 2014

(54) ELECTRONIC DEVICE HAVING MULTIPLE HUMAN-MACHINE INTERFACES AND METHOD FOR RUNNING MULTIPLE HUMAN-MACHINE INTERFACES

(71) Applicant: Atrust Computer Corp., Taoyuan County (TW)

(72) Inventors: Hoe-To CHO, Taoyuan County (TW); Ya-Fu WEI, Taoyuan County (TW); Kuo-Tung TSENG, Taoyuan County (TW); Shou-Lien CHEN, Taoyuan County (TW); Yao-Chen YU, Taoyuan County (TW)

(73) Assignee: Atrust Computer Corp., Taoyuan County (TW)

(21) Appl. No.: 14/055,282

(22) Filed: Oct. 16, 2013

(30) Foreign Application Priority Data
Jan. 18, 2013 (TW) 102102155

(51) Int. Cl. G06F 1/26

(52) U.S. Cl. CPC G06F 1/26
USPC 713/300

(57) ABSTRACT

An electronic device having multiple human-machine interfaces and a method for running multiple human-machine interfaces are provided. The electronic device includes a host and a plurality of human-machine interfaces. The host has a processor, and each of the human-machine interfaces is disposed in the host and includes a power setting module. The processor analyzes all the human-machine interfaces to determine a target interface in which the enabled power setting module is included, so as to perform message input and output operations of the target interface.

### CROSS-REFERENCE TO RELATED APPLICATION

This application claims the benefit of Taiwan Patent Application No. 102102155, filed on Jan. 18, 2013, which is hereby incorporated by reference for all purposes as if fully set forth herein.

### BACKGROUND OF THE INVENTION

1. Field of Invention

The present invention relates to having multiple human operating interfaces, and more particularly to an electronic device having multiple human-machine interfaces and a method for running multiple human-machine interfaces.

2. Related Art

In the prior art, executing program codes and performing data computing and signal input/output (I/O) processing are essential functions of an electronic device having a computing capability, such as a personal computer (PC), a server, and other similar devices. However, during program computing, a processor of the electronic device, such as a central processing unit (CPU) and a microprocessor, is waiting for the instruction of a user in most of the time. In order to improve the efficacy of the electronic device, research persons develop a technology of manipulating a computer by multiple persons, that is, the single electronic device can provide multiple operation platforms for different users at the same time. However, when the electronic device is enabled, all the hardware is in a powered-on running state.

### SUMMARY OF THE INVENTION

The present invention is directed to an electronic device having multiple human-machine interfaces and an interface running method, which enables corresponding human-machine interfaces through electric power control.

The electronic device disclosed by the present invention comprises a host, and the host comprises a processor. A plurality of human-machine interfaces is disposed in the host, and each of the human-machine interfaces comprises a power setting module. The processor finds out a target interface from all the human-machine interfaces according to the enabled power setting module, and performs message input and output operations to the target interface.

The method for running multiple human-machine interfaces disclosed by the present invention is applicable in an electronic device having a plurality of human-machine interfaces, each human-machine interface comprising a power setting module and being connected to a plurality of control devices. The method comprises: determining, by a processor of the electronic device, a target interface in which the enabled power setting module is included; and performing, by the processor, message input and output operations to the target interface.

The present invention is characterized in that: (1) through electric power control, the host only runs the human-machine interface set to be enabled by electric power. Other than common hardware, the hardware deployed by other human-machine interfaces is in a disabled or power-off state, so that electric power consumption of the electronic device can be reduced; (2) a user may enable or disable the human-machine interfaces through the power setting module, thereby improving convenience of use; (3) by using the multiple human-machine interfaces, the electronic device can be used by multiple users at the same time, so that the utilization efficiency of the hardware of the electronic device is improved, and the configuration cost of the electronic device is reduced; and (4) the technology disclosed by the present invention is adaptable for various electronic devices having the computing capability, and has a high adaptability.

### BRIEF DESCRIPTION OF THE DRAWINGS

The present invention will become more fully understood from the detailed description given herein below for illustration only, and thus are not limitative of the present invention, and wherein:

FIG. 1 is a first hardware structural view of an electronic device according to an embodiment of the present invention;

FIG. 2 is a first architecture block diagram of the electronic device according to the embodiment of the present invention;

FIG. 3 is a second hardware structural view of the electronic device according to the embodiment of the present invention;

FIG. 4 is a second architecture block diagram of the electronic, device according to the embodiment of the present invention;

FIG. 5 is a third architecture block diagram of the electronic device according to the embodiment of the present invention;

FIG. 6 is a fourth architecture block diagram of the electronic device according to the embodiment of the present invention;

FIG. 7 is a fifth architecture block diagram of the electronic device according to the embodiment of the present invention;

FIG. 8 is a flow chart of a method for running multiple human-machine interfaces according to an embodiment of the present invention; and

FIG. 9 is a flow chart of a running extension of the multiple human-machine interfaces according to an embodiment of the present invention.

### DETAILED DESCRIPTION OF THE INVENTION

Hereinafter, preferred embodiments of the present invention are illustrated in detail with reference to the accompanying drawings.

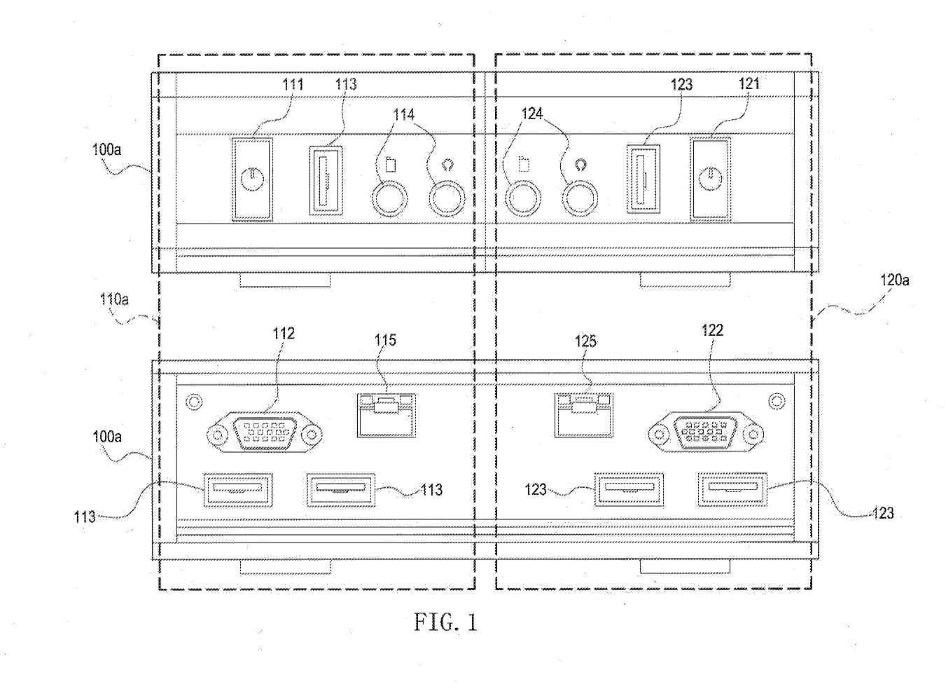

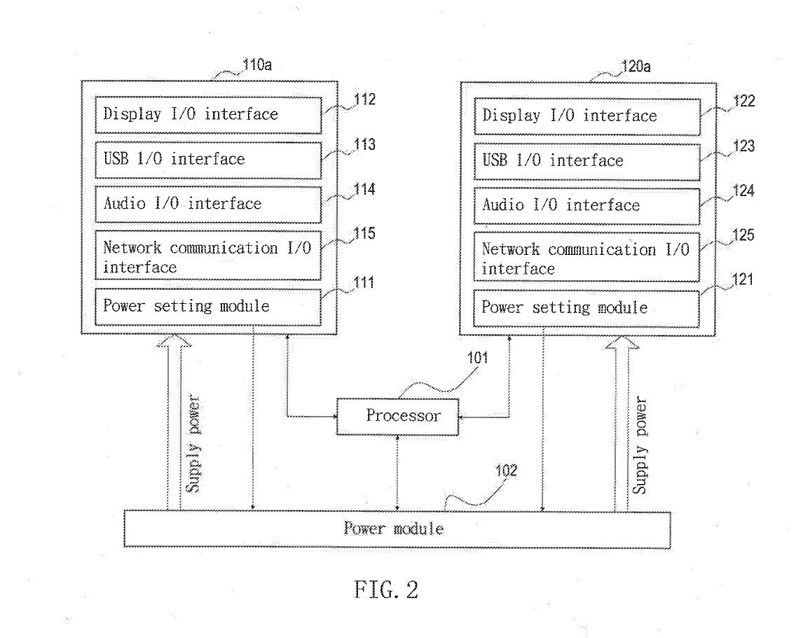

First, referring to FIG. 1, a first hardware structural view of an electronic device according to an embodiment of the present invention is shown, and referring to FIG. 2 at the same time, a first architecture block diagram of the electronic device according to the embodiment of the present invention is shown.

The electronic device includes a host 100a, and the host 100a has a processor 101 and a power module 102. A plurality of human-machine interfaces is disposed on the host 100a, and each of the human-machine interfaces is disposed on the host 100a and has a plurality of input/output (I/O) interfaces and a power setting module. Two or more human-machine interfaces can be configured by the host 100a, and each of the human-machine interfaces may include I/O interfaces of the same type or different types, depending on the requirements of the designer.

In this embodiment, two human-machine interfaces (110a, 120a) are taken as examples, where each human-machine interface includes I/O interfaces of the same type. Each human-machine interface has a display I/O interface (such as DisplayPort, D-sub, DVI, and HDMI), a USB I/O interface, an audio I/O interface, and a network communication interface. That is, the human-machine interface 110a has a power setting module 111, a display I/O interface 112, a USB I/O interface 113, an audio I/O interface 114; and a network communication I/O interface 115; and the human-machine interface 120a has a power setting module 121, a display I/O interface 122, a USB I/O interface 123, an audio I/O interface 124, and a network communication I/O interface 125.

Various types of I/O interface are used to connect a control device corresponding to the interface. For example, the display I/O interfaces (112,122) are connected to a monitor; the network communication I/O interfaces (115,125) are connected to a modem, a server, or other network devices with network communication capability via a network cable; the audio I/O interfaces (114,124) are connected to a sound collector (a microphone) and/or a speaker; and the USB I/O interfaces (113,123) are connected to an external electronic device. Furthermore, it is set that a keyboard I/O interface is connected to a keyboard; a mouse I/O interface is connected to a mouse; and a series port I/O interface is connected to an external electronic device via a series connection cable.

The power setting modules (111,121) are connected to the power module 102 (such as a power supply or a battery module), and each of the power setting modules (111,121) is, but not limited to, an element having state setting, switching, or triggering capability such as a switch (press-type, switch-type), or a sensing element (sound-sensing, light-sensing, pressure-sensing), and an element, module, circuit, or device with similar functions is also applicable. When the power module 102 is static, the power module 102 may start running under the control of any one of the power setting modules (111,121), thereby supplying power to each element of the electronic device. The state of the power setting module operated by the user may be set as “enabled.”

The processor 101 analyzes which one of the power setting modules (111,121) is set to be enabled, and considers the human-machine interface in which the enabled power setting module is included as a target interface, so as to perform message input and output operations to the target interface or further to the control device connected thereto.

The processor 101 may firstly enable the above target interface. For example, the power setting module 111 is set to be enabled, and the human-machine interface 110a is the target interface. The processor 101 may firstly enable functions of various components such as hardware, software, circuits, and modules of the human-machine interface 110a. That is to say, the hardware of the human-machine interface 110a is originally in a state with low power consumption such as a sleeping state, a state of powering on partial elements, or a stand-by state. The processor 101, when determining that the human-machine interface 110a should be enabled, may wake up the human-machine interface 110a. Essential elements or all elements of the human-machine interface 110a are thus powered to run, or are further powered to achieve high running efficacy.

Alternatively, by means of circuit design or module design, each human-machine interface (110a,120a), in an initial state, does not acquire the electric power provided by the power module 102. When the processor 101 enables the human-machine interface, for example, the human-machine interface 120a (that is, the power setting module 121 is set to be enabled), the processor 101 makes the power module 102 supply power to the human-machine interface 120a. After the human-machine interface 120a acquires power, the functions of various components such as the hardware, software, circuits, and modules included therein can be put into use.

However, the processor 101, when being a single-core processor, adapts to the human-machine interfaces (110a, 120a) via a multiplexing method. Moreover, the processor 101, when being a multi-core processor, may configure one or more core modules correspondingly for each human-machine interface, so that each of the human-machine interfaces (110a, 120a) may run cooperatively with a dedicated core module.

Afterwards, when the user re-operates the power setting module 121, the state thereof is set as “disabled,” so that the processor 101 disables the human-machine interface 120a. The disabling operation is opposite to the above enabling operation, that is, disabling the functions of various components such as hardware, software, circuits, and modules of the human-machine interface 120a or making the power module 102 stop the power supply operation to the human-machine interface 120a.

Further, when the processor 101 determines that all the human-machine interfaces (110a,120a) are in the disabled state, or the power module 102 has stopped supplying power to all the human-machine interfaces (110a, 120a), the processor 101 may perform shutdown operation of the host 100a. The power module 102 may stop the power supply operation to stop supplying power to each element of the host, so that the host 100a enters the shutdown state.

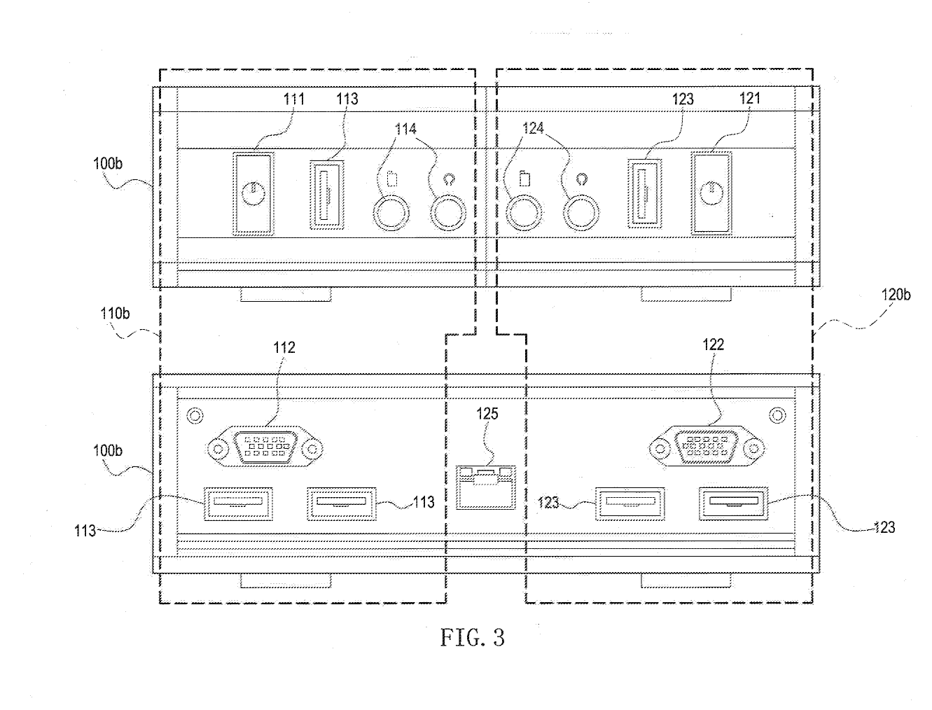

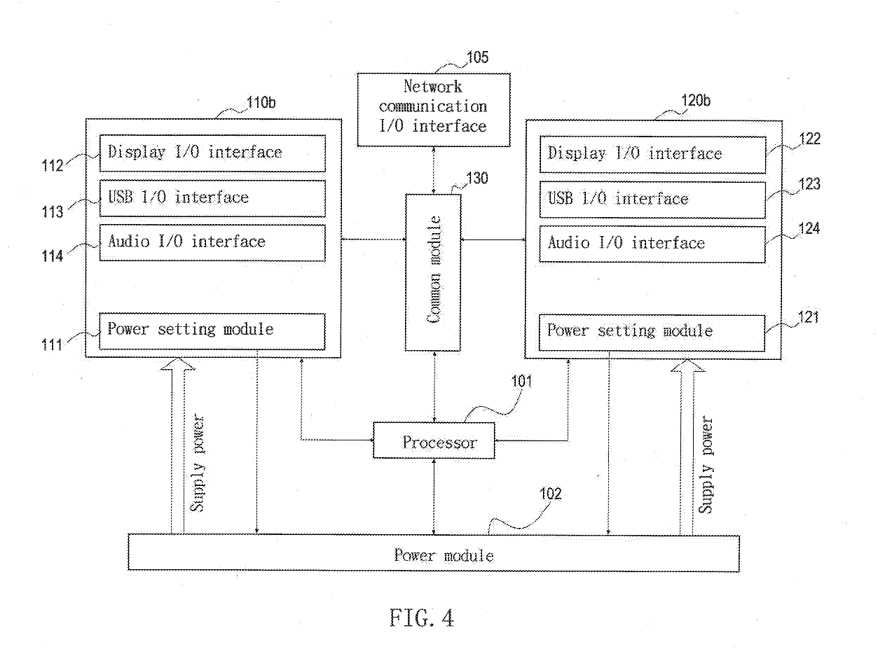

Next, referring to FIG. 3, a second hardware structural view of the electronic device according to the embodiment of the present invention is shown, and referring to FIG. 4 at the same time, a second architecture block diagram of the electronic device according to the embodiment of the present invention is shown.

The difference as compared with the preceding embodiment lies in that, the host 100b further includes a common module 130. The common module 130 may be an image processor (such as an image processing chip or circuit) for connecting to a display I/O interface (112, 122) of each of the human-machine interfaces (110b, 120b), a Universal Serial Bus (USB) processor (USB processing chip or circuit) for connecting to a USB I/O interface (113, 123) of each human-machine interface, an audio processor (such as an audio processing chip or circuit) for connecting an audio I/O interface (114, 124) of each of the human-machine interfaces (110b, 120b), or an independent operating interface, such as a network communication I/O interface 105 as shown in FIG. 3 and FIG. 4.

When the processor 101 determines that more than two target interfaces are enabled, and the target interfaces are operated by the user to cooperate the common module 130 to perform signal input and output operations, the processor 101 makes the common module 130 to cooperate with these target interfaces in a multiplexing manner to perform the message input and output operations. The multiplexing manner is, for example, Time-Division Multiplexing (TDM), Parallel Computing, or Distributed Computing.

For instance, the host as shown in FIG. 3 and FIG. 4 has two human-machine interfaces (110b, 120b), but the network communication I/O interface 105 merely has one network connection port. When the two human-machine interfaces (110b, 120b) are enabled, the human-machine interfaces (110b, 120b) can cooperate with the network communication I/O interface 105 to perform network communication operations, so as to share the network function of the electronic device.

For another instance, the host as shown in FIG. 3 and FIG. 4 has two human-machine interfaces, and the common module 130 is a display processor and is connected to two monitor I/O interfaces (112, 122). It is assumed that, the two display I/O interfaces (112, 122) are connected to two monitors (not shown). When the human-machine interfaces (110b, 120b) are both enabled, the common module 130 (the display processor) processes message input and output operations between two human-machine interfaces and two monitors in the multiplexing manner.

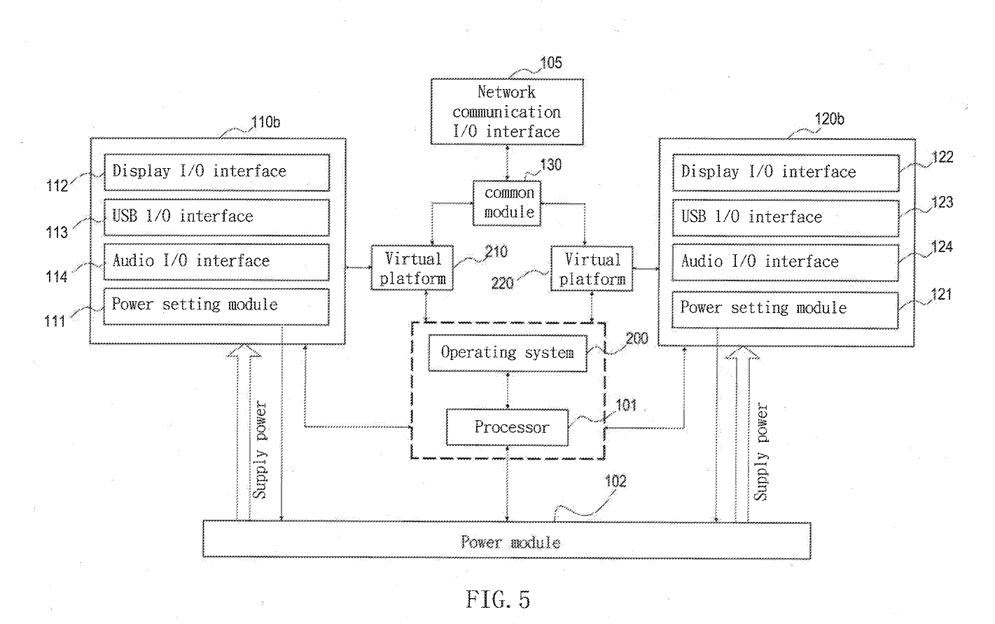

Then, referring to FIG. 5, a third architecture block diagram of the electronic device according to the embodiment of the present invention is shown, which is in combination with the operating form of an operating system 200. Please refer to FIG. 3 and FIG. 4 in combination with FIG. 5 for better understanding. The operating system 200 is pre-installed in the electronic device 100b. When the operating system 200 is executed, the processor 101 may firstly determine which one of the power setting modules (111, 121) is enabled, find out the above-mentioned target interface from all the human-machine interfaces (110b, 120b), and construct a virtual platform corresponding to each target interface via the operating system 200. The processor 101 may cooperate with the constructed virtual platform to perform message input and output operations to the target interface corresponding to the virtual platform.

For instance, the human-machine interface 110b is the target interface, and the virtual platform 210 is constructed to correspond to the human-machine interface 110b. If the human-machine interface 120b is the abovementioned target interface, the virtual platform 220 is constructed to correspond to the human-machine interface 120b. If the human-machine interface 110b and the human-machine interface 120b both are the abovementioned target interfaces, the virtual platform 210 and the virtual platform 220 are both constructed to individually correspond to the human-machine interfaces (110b and 120b).

Similarly to FIG. 4, the host 100b has the common module 130, and when the processor 101 determines that at least two virtual platforms, such as the virtual platform 210 and the virtual platform 220, need to perform signal input and output operations to the common module 130, the processor 101 cooperates with the operating system 200, so as to require the common module 130 to cooperate with each of the virtual platforms (210, 220) and the human-machine interface (110b, 120b) corresponding to each of the virtual platforms (210, 220) in a multiplexing manner to perform message input and output operations.

Further, a user or an administrator of a system/device with the highest authority may set an interface type and quantity of the human-machine interfaces that can be used by each virtual platform through an operating system or firmware of the device (or an embedded system). For example, the virtual platform 210 has the right of using the display I/O interface 112, the USB I/O interface 113, and the network communication I/O interface 105 extendedly connected to the common module 130. The virtual platform 220 has the right of using the display I/O interface 122 and the audio I/O interface 124. Things like this are determined according to the user's requirements and the administrator's decision on authority allocation, which are not repeated herein.

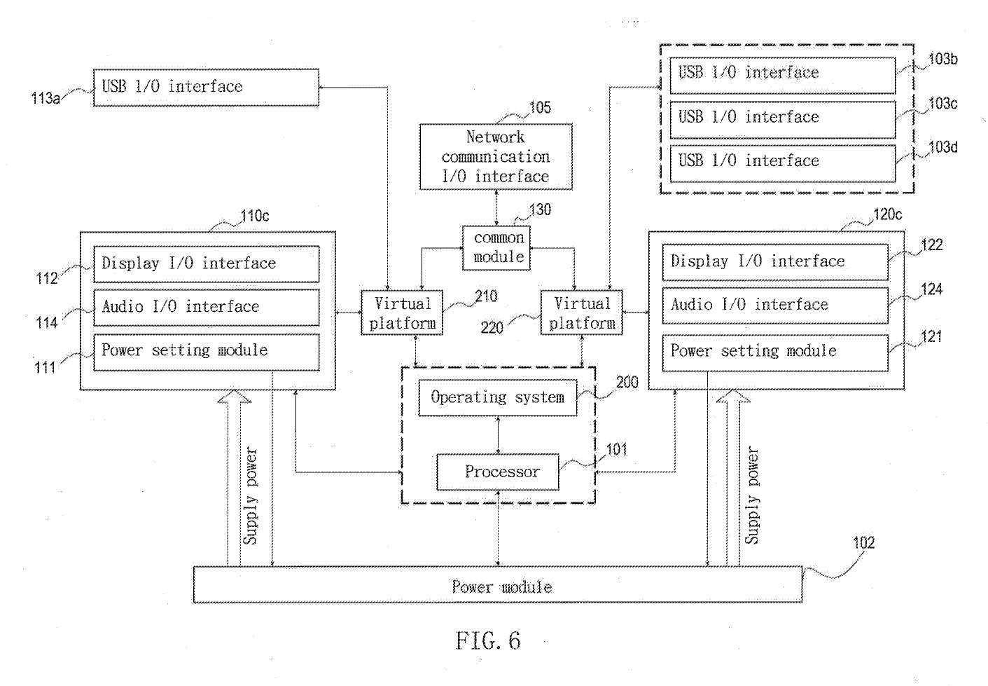

Then, referring to FIG. 6, a fourth architecture block diagram of the electronic device according to the embodiment of the present invention is shown, which is in combination with the operating form of an operating system 200. However, the difference from the above embodiment lies in that, each of the human-machine interfaces (110c, 120c) of the host has I/O interfaces belonging to the human-machine interface, as well as multiple I/O interfaces which do not belong to the human-machine interfaces. When the virtual platforms (210, 220) are constructed, the processor 101 cooperates with the operating system 200 to set the I/O interface that can be used by each of the virtual platforms (210, 220). Furthermore, the processor 101 may cooperate with the operating system 200 to set the I/O interface that can be used by each of the virtual platforms (210, 220) and is not included in the human-machine interfaces (110c, 120c), or further make a setting for a connection port.

For instance, when the virtual platform 210 is constructed, it is set that the network communication I/O interface 105 can be used, but when the virtual platform 220 is constructed, it is set that the network communication I/O interface 105 cannot be used.

For another instance, when the virtual platform 210 is constructed, it is set that the USB I/O interface (103a) can be used, and when the virtual platform 220 is constructed, it is set that the USB I/O interfaces (103b, 103c, 103d) can be used.

In such way, each user may use different functions on the electronic device, so as to achieve personalized setting or further control on authority.

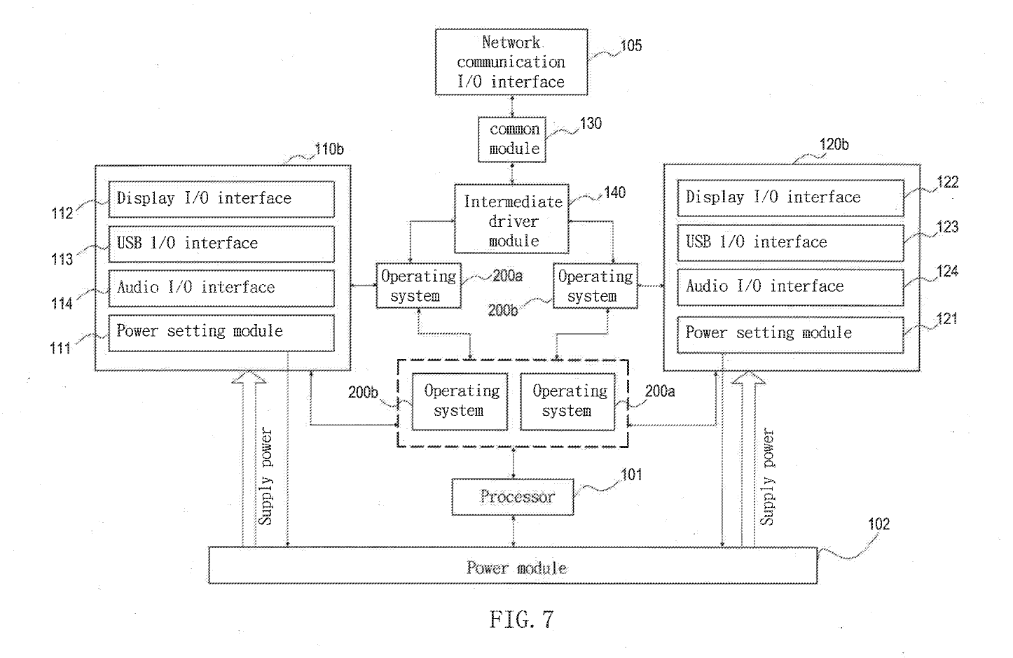

Then, referring to FIG. 7, a fifth architecture block diagram of the electronic device according to the embodiment of the present invention is shown, which is in combination with the operating form of multiple operating systems. The difference from FIG. 5 lies in that, a plurality of operating systems is installed in the host, and two operating systems (200a, 200b) are taken as an example, but are not used as a limitation.

The processor 101 may execute a target operating system, and cooperate with the target operating system to perform message input and output operations to a target interface. The target operating system may be selected by the user according to the enabled human-machine interface. For example, the operating system 200a is executed to correspond to the human-machine interface 110b, and the operating system 200b is executed to correspond to the human-machine interface 120b. Alternatively, the operating system that can be executed by each of the human-machine interfaces (110b, 120b) can be preset, and according to the enabled human-machine interface, the processor 101 executes the operating system corresponding to the human-machine interface.

The difference from the setting of the virtual platform lies in that, when the operating systems (200a, 200b) are executed, the processor 101 sets and uses the available I/O interface of the operating systems (200a, 200b) through the operating systems (200a, 200b) or the firmware (or the embedded system) built in the host.

Likewise, referring to FIG. 7, the host includes an intermediate driver module 140 and a common module 130. The intermediate driver module 140, as whole device architecture, is connected between the common module 130 and each of the operating systems (200a, 200b).

The intermediate driver module 140 may be software, hardware, or a combination of software and hardware, such as a chip, an integrated circuit (IC), an electronic unit; a device, and a circuit, to cooperate executing software, as firmware.

When the processor 101 determines that at least two operating systems perform signal input and output to the common module 130, for example, when the operating system 200a and the operating system 200b are both executed, the processor 101 makes the operating system 200a and the operating system 200b control the common module 130 through the intermediate driver module 140 in a multiplexing manner.

The intermediate driver module 140 may convert the data transmitted between the intermediate driver module 140 and each of the operating systems (200a, 200b) with the data transmitted between the intermediate driver module 140 and the common module 130.

For example, when the processor 101 controls the common module 130 via the operating system 200a, a control message for the common module 130 may be sent. The control message is converted by the intermediate driver module 140 into a control parameter of the intermediate driver module 140 for the common module 130, and the intermediate driver module 140 controls the running of the common module 130. A response message returned by the common module 130 is converted, by the intermediate driver module 140 into a message format for the message interaction between the operating system 200a and the common module 130, and the response message converted by the intermediate driving module 140 is acquired through the operating system 200a.

Similarly, when controlling the control module 130 through the operating system 200b, the processor 101 may send a control message for the common module 130. The control message is converted by the intermediate driver module 140 into a control parameter of the intermediate driver module 140 for the common module 130, and the intermediate driver module 140 controls the running of the common module 130. A response message returned by the common module 130 is converted by the intermediate driver module 140 into a message format for the message interaction between the operating system 200b and the common module 130, and the response message converted by the intermediate driving module 140 is acquired through the operating system 200b.

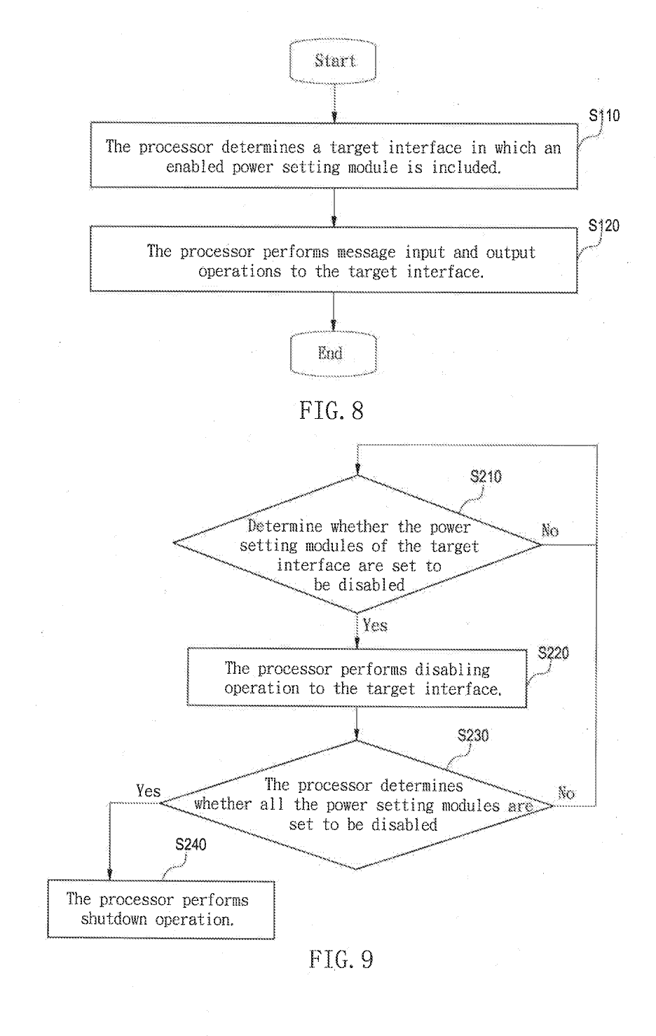

FIG. 8 is a flow chart of a method for running multiple human-machine interfaces according to an embodiment of the present invention which discloses the method for determining the human-machine interface's switching on and the corresponding operation thereof. Please refer to FIG. 1 to FIG. 7 in combination with FIG. 8 for better understanding. The method includes the following steps.

The processor 101 determines a target interface in which the enabled power setting module (111, 121) is included (Step S110). This step has different implementation manners according to different architecture of the device as mentioned above.

As shown in FIG. 2, the processor 101 may enable the target interface, i.e., enable the functions of various components such as hardware, software, circuits, and modules of the target interface.

Referring to FIG. 2, the processor 101 make the power module 102 to perform power supply operation to the target interface in which the enabled power setting module (111 and/or 121) is included. After the human-machine interface (that is, the above target interface) is powered on, the functions of various components such as hardware, software, circuits, and modules in the human-machine interface can be put in use.

Then, the processor 101 performs message input and output operations to the target interface (Step S120). This step has different implementation manners according to different architecture of the device as mentioned above.

Referring to FIG. 2, the processor 101 performs message input and output operations to the target interface.

As shown in FIG. 4, the host 100b includes a common module 130. When more than two human-machine interfaces (110b, 120b) are enabled, and the human-machine interfaces (110b, 120b) operated by the user need to cooperate with the common module 130 to perform signal input and output operations, the processor 101 makes the common module 130 to cooperate with these human-machine interfaces (110b, 120b) in a multiplexing manner to perform message input and output operations.

As shown in FIG. 5 and FIG. 6, the host has an operating system 200, and a virtual platform (210 and/or 220) corresponding to each target interface (the human-machine interface 110b and/or the human-machine interface 120b) is constructed through the operating system 200. The processor 101 may cooperate with the constructed virtual platform (210 and/or 220) to perform message input and output operations to the target interface corresponding to the virtual platform (210 and/or 220).

When the processor determines that more than two virtual platforms perform signal input and output to the common module, such as the human-machine interfaces (110b, 120b), the processor 101 may make the common module 130 cooperate with the virtual platforms (210, 220) to perform message input and output operations to the target interface corresponding to each of the virtual platforms (210, 220) in a multiplexing manner.

As shown in FIG. 7, the host includes more than to operating systems, for example two operating systems (200a, 200b), and the processor 101 selects a target operating system from all the operating systems (200a, 200b) for execution.

Then, the processor 101 cooperates with the target operating system to perform message input and output operations to the target interface. When the processor 101 determines that more than two operating systems, such as the operating systems (200a, 200b), perform signal input and output to the common module 130, the processor, in a multiplexing manner, makes the operating systems (200a, 200b) to respectively control the common module 130 through the intermediate driver module 140.

FIG. 9 is a flow chart of a running extension of multiple human-machine interfaces according to an embodiment of the present invention which discloses the method for determining the human-machine interface's switching off and the corresponding operation thereof during the course indicated in FIG. 8, which includes the following steps.

The processor 101 determines whether the power setting modules (111, 121) of the target interface are set to be disabled (Step S210), if not, the procedure returns to Step S210 to continuously make determination, and if yes, the processor 101 performs disabling operation to the target interface (Step S220). As stated above, the processor 101 performs function disabling operation to the target interface. Alternatively, the processor 101 makes the power module 102 to stop performing the power supply operation to the target interface.

Then, the processor 101 determines whether all the power setting modules (111, 121) are set to be disabled (Step S230), if yes, the processor 101 performs shutdown operation (Step S240), that is, makes the power module 102 stop the power supply to each element of the host, and if not, the procedure returns to Step S210.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An electronic device having multiple human-machine interfaces, comprising:
a host, comprising a processor; and
a plurality of human-machine interfaces, disposed in the host, each human-machine interface comprising a power setting module,
wherein, the processor performs message input and output operations to a target interface in which the enabled power setting module is included, among the human-machine interfaces.

2. The electronic device having multiple human-machine interfaces according to claim 1, wherein, when any one of the power setting modules is set to be enabled, the processor performs an enabling operation for the target interface in which any one of the enabled power setting modules is included.

3. The electronic device having multiple human-machine interfaces according to claim 1, wherein, when the power setting module of the target interface is set to be disabled, the processor performs a disabling operation to the target interface.

4. The electronic device having multiple human-machine interfaces according to claim 3, wherein, when the power setting modules are all set to be disabled, the processor performs a shutdown operation to the host.

5. The electronic device having multiple human-machine interfaces according to claim 1, wherein the host comprises a power module, the power module is connected to the power setting modules, and the processor make the power module perform a power supply operation to the target interface.

6. The electronic device having multiple human-machine interfaces according to claim 5, wherein, when the power setting module of the target interface is set to be disabled, the processor make the power module stop the power supply operation to the target interface.

7. The electronic device having multiple human-machine interfaces according to claim 5, wherein, when the processor determines that the power setting modules are all set to be disabled, the processor make the power module perform the disabling operation.

8. The electronic device having multiple human-machine interfaces according to claim 1, wherein the host executes an operating system, the processor constructs a virtual platform corresponding to the target interface via the operating system, and the processor cooperates with the virtual platform to perform message input and output operations to the target interface.

9. The electronic device having multiple human-machine interfaces according to claim 8, wherein the host further comprises a common module, the processor, when determining that at least two virtual platforms perform signal input and output to the common module, makes the common module to cooperate with the at least two virtual platforms and the target interface corresponding to each of the virtual platforms in a multiplexing manner to perform message input and output operations.

10. The electronic device having multiple human-machine interfaces according to claim 8, wherein the processor, when determines that at least two virtual platforms are constructed, the processor cooperates with each of the virtual platform to perform message input and output operations to the target interface which the virtual platform is corresponding to.

11. The electronic device having multiple human-machine interfaces according to claim 8, wherein the host further comprises a plurality of input/output (I/O) interfaces, and the processor cooperates with the operating system to set part of the I/O interfaces that are available for the virtual platform.

12. The electronic device having multiple human-machine interfaces according to claim 1, wherein the host stores a plurality of operating systems, the processor executes a target operating system, so as to cooperate with the target operating system to perform message input and output operations to the target interface.

13. The electronic device having multiple human-machine interfaces according to claim 12, wherein the host further comprises an intermediate driver module and a common module, the intermediate driver module is connected to the operating systems and the common module, the processor, when determining that at least two virtual platforms perform the signal input and output operations to the common module, makes the at least two operating systems respectively control the common module through the intermediate driver module in a multiplexing manner.

14. The electronic device having multiple human-machine interfaces according to claim 13, wherein the intermediate driver module is used to convert data transmitted between the intermediate driver module and each of the operating systems with data transmitted between the intermediate driver module and the common module.

15. The electronic device having multiple human-machine interfaces according to claim 12, further comprising a plurality of I/O interfaces, wherein the processor sets part of the I/O interfaces that can be used by the target operating system.

16. The electronic device having multiple human-machine interfaces according to claim 1, wherein the host further comprises a common module, the processor, when determining that at least two target interfaces cooperate with the common module to perform the signal input and output operations, makes the common module to cooperate with the at least two target interfaces in a multiplexing manner to perform message input and output operations.

17. The electronic device having multiple human-machine interfaces according to claim 16, wherein the common module comprises an image processor for connecting to a display I/O interface of the human-machine interfaces.

18. The electronic device having multiple human-machine interfaces according to claim 16, wherein the common module comprises an audio processor for connecting to an audio I/O interface of the human-machine interfaces.

19. The electronic device having multiple human-machine interfaces according to claim 16, wherein the common module comprises a network communication module for connecting to a network communication I/O interface of the human-machine interfaces.

20. The electronic device having multiple human-machine interfaces according to claim 1, wherein each of the human-machine interfaces comprises a plurality of I/O interfaces, and the I/O interfaces comprise a display I/O interface.

21. The electronic device having multiple human-machine interfaces according to claim 1, wherein each of the human-machine interfaces comprises a plurality of I/O interfaces, and the I/O interfaces comprise an audio I/O interface.

22. The electronic device having multiple human-machine interfaces according to claim 1, wherein each of the human-machine interfaces comprises a plurality of I/O interfaces, and the I/O interfaces comprise a network communication I/O interface.

23. The electronic device having multiple human-machine interfaces according to claim 1, wherein each of the human-machine interfaces comprise a plurality of I/O interfaces, and the I/O interfaces comprise a keyboard I/O interface.

24. The electronic device having multiple human-machine interfaces according to claim 1, wherein each of the human-machine interfaces comprises a plurality of I/O interfaces, and the I/O interfaces comprise a mouse I/O interface.

25. The electronic device having multiple human-machine interfaces according to claim 1, wherein each of the human-machine interfaces comprise a plurality of I/O interfaces, and the I/O interfaces comprise a series port I/O interface.

26. The electronic device having multiple human-machine interfaces according to claim 1, wherein each of the human-machine interfaces comprise a plurality of I/O interfaces, and the I/O interfaces comprise a universal serial bus (USB) I/O interface.

27. A method for running multiple human-machine interfaces, applicable in an electronic device having a plurality of human-machine interfaces, and each human-machine interface comprising a power setting module, comprising:
determining, by a processor of the electronic device, a target interface in which the enabled power setting module is included; and
performing, by the processor, message input and output operations to the target interface.

28. The method for running multiple human-machine interfaces according to claim 27, wherein, in the step of performing, by the processor, message input and output operations to the target interface, the processor enables the target interface, so as to perform the message input and output operations to the target interface.

29. The method for running multiple human-machine interfaces according to claim 27, wherein, after the step of performing, by the processor, message input and output operations to the target interface, further comprises:
when the processor determines that the power setting module of the target interface is set to be disabled, performing, by the processor, a disabling operation to the target interface.

30. The method for running multiple human-machine interfaces according to claim 27, wherein the electronic device comprises a power module, and the step of performing, by the processor, message input and output operations to the target interface, further comprises:
making, by the processor, the power module perform a power supply operation to the target interface in which the enabled power setting module is included.

31. The method for running multiple human-machine interfaces according to claim 30, wherein the electronic device comprises a power module, and after the step of performing, by the processor, message input and output operations to the target interface, further comprises:
when the processor determines that the power setting module of the target interface is set to be disabled, making, by the processor, the power module to disable the power supply operation to the target interface.

32. The method for running multiple human-machine interfaces according to claim 31, wherein, after the step of performing, by the processor, message input and output operations to the target interface, further comprises:
when determining that the power setting modules are all set to be disabled, making, by the processor, the power module perform a disabling operation.

33. The method for running multiple human-machine interfaces according to claim 27, wherein the electronic device executes an operating system, and the step of performing, by the processor, message input and output operations to the target interface, further comprises:
constructing, by the processor, a virtual platform corresponding to the target interface via the operating system; and
cooperating, by the virtual platform, with the processor to perform message output and input to control devices of the target interface.

34. The method for running multiple human-machine interfaces according to claim 33, wherein the electronic device further comprises a common module, and the step of performing, by the processor, message input and output operations to the target interface, further comprises:
when determining at least two virtual platforms perform the signal input and output to the common module, cooperating, by the processor, with the operating system to require the common module to cooperate with each of the virtual platforms and the target interface corresponding to each of the virtual platforms in a multiplexing manner to perform message input and output operations.

35. The method for running multiple human-machine interfaces according to claim 27, wherein the electronic device stores a plurality of operating systems, and the step of performing, by the processor, message input and output operations to the target interface, further comprises:
selecting, by the processor, a target operating system from the operating systems for execution; and
cooperating, by the processor, with the target operating system to perform message input and output operations to the target interface.

36. The method the running multiple human-machine interfaces according to claim 27, wherein the electronic device comprises an intermediate driver module and a common module, and the step of performing, by the processor, message input and output operations to the target interface further comprises:
when determining that at least two operating systems performs signal input and output to the common module, making, by the processor, the at least two operating systems respectively to control the common module through the intermediate driver module in a multiplexing manner.
